(19) United States
(12) Patent Application Publication
(10) Pub. No.: US 2025/0214900 A1
(43) Pub. Date: Jul. 3, 2025

(54) METHOD FOR MANUFACTURING CERAMIC MATERIAL, CERAMIC MATERIAL AND USE OF CERAMIC MATERIAL

(71) Applicants: PETRÓLEO BRASILEIRO S.A. - PETROBRAS, Rio de Janeiro (BR); UNIVERSIDADE FEDERAL DE MINAS GERAIS - UFMG, Belo Horizonte (BR)

(72) Inventors: Priscila CRISTH FONSECA ALVES, Belo Horizonte (BR); Jailton FERREIRA DO NASCIMENTO, Rio de Janeiro (BR); Débora GUIMARÃES DA SILVA, Belo Horizonte (BR); Leonardo DOS SANTOS PEREIRA, Rio de Janeiro (BR); Wander Luiz VASCONCELOS, Nova Lima (BR); Darley CARRIJO DE MELO, Rio de Janeiro (BR)

(21) Appl. No.: 18/990,029

(22) Filed: Dec. 20, 2024

(30) Foreign Application Priority Data
Dec. 28, 2023 (BR) 1020230277624

(51) Int. Cl. C04B 35/10; B01D 61/14; B01D 67/00; B01D 69/04; B01D 71/02; B28B 1/00; C04B 35/626; C04B 35/632; C04B 35/64; C04B 38/00; C04B 38/06

(52) U.S. Cl. CPC C04B 35/10; B01D 61/147; B01D 67/0046; B01D 69/04; B01D 71/025; B28B 1/007; C04B 35/62635; C04B 35/6264; C04B 35/62655; C04B 35/632; C04B 35/64; C04B 38/0054; C04B 38/0605; C04B 2235/3217; C04B 2235/3255; C04B 2235/606; C04B 2235/6562; C04B 2235/6565; C04B 2235/6567

(57) ABSTRACT

The present disclosure relates to embodiments of a method for manufacturing a ceramic material comprising the steps of (a) homogenizing aluminum oxide, niobium pentoxide and solvent; (b) ultrasonicating the blend obtained in step (a); (c) adding an aliquot of the prepared suspension to the empty cavity of a mold, particularly between the polymeric mold and the metal mold; (d) immersing the mold into a coolant liquid-containing bath for sufficient time to ensure that all parts are completely frozen; (e) removing the ceramic body from the mold; (f) removing the solidified phase by means of sublimation hence obtaining a green tube; and (g) sintering the green tube, so as to obtain a solid structure. The present disclosure further relates to embodiments of a ceramic material and its use to manufacture a microfiltration membrane and/or a membrane support for fluid separation.

### FIELD OF THE DISCLOSURE

The present disclosure relates to a method for manufacturing a ceramic material comprising the steps of (a) homogenizing aluminum oxide, niobium pentoxide and solvent; (b) ultrasonicating the blend obtained in step (a); (c) adding an aliquot of the prepared suspension to the empty cavity of a mold, particularly between a polymeric mold and a metal mold; (d) closing the mold; (e) immersing the mold into a coolant liquid-containing bath to ensure that all parts are completely frozen; (f) removing the ceramic body from the mold; (g) removing the solidified phase by means of sublimation hence obtaining a green tube; and (h) sintering the green tube, so as to obtain a solid structure.

The present disclosure further relates to a ceramic material and its use to manufacture a microfiltration membrane and/or a membrane support for fluid separation.

The disclosure can be applied in the oil and gas industry, preferably as a membrane or filtration support. Furthermore, the present disclosure has the potential to be used in other fields, such as thermal insulators, biomedical implants, catalysis supports, solid oxide fuel cells and chemical reactors.

### BACKGROUND OF THE DISCLOSURE

Membranes act as a selective barrier that separates two phases, totally or partially restricting the transport of one or more elements. Polymeric membranes currently dominate the industrial application market due to their low cost, processability and scalability. However, their low mechanical, thermal and chemical stabilities restrict their use in some practical applications.

In this context, the evaluation of ceramic membranes as an advantageous alternative to polymeric membranes becomes extremely relevant, mainly due to their resilience features under high pressure, temperature and chemical stringency application conditions.

Ceramic membranes can be defined as a filter medium made of inorganic materials, developed for segregation processes based on differences in fluid properties such as size, charge and the like. Its structure consists of an interconnected network of pores that can be manipulated to present a specific size distribution, allowing a precise control of the separation process.

During filtration, there must be some chemical or physical difference between the two components to be separated and a driving force to cause separation, such as a pressure gradient. Feeding over the ceramic surface and the flow of fluids through the filter wall creates pressure variations in the tube thickness and is responsible for the transport of particles through the material thickness.

Membranes can be composed of a single substrate or by the deposition of successive layers on a porous support. Deposition of successive layers can act to gradually reduce the pore size in the substrate and modify the surface characteristics.

A commonly used strategy to add mechanical strength to ceramic materials is the introduction of sintering agents during the forming process. In the instance of ceramics made mainly of alumina, several oxides are mentioned in the literature, such as magnesium oxide (MgO), yttrium oxide (Y₂O₃), lanthanum oxide (La₂O₃), silicon dioxide (SiO₂), zirconium dioxide (ZrO₂), titanium dioxide (TiO₂), among others (YANG et al., 2020). The choice of sintering agent depends on the desired properties, the needs of each application and the processing conditions. A promising approach is the use of niobia (niobium pentoxide—Nb₂O₅) as a sintering agent and structure reinforcement for alumina tubes obtained by freeze-casting.

The crystal structure of niobia differs from alumina and creates a heterogeneous structure when incorporated into the ceramic matrix. This difference inhibits crack propagation and improves the mechanical properties of the material. Furthermore, aluminum niobate prevents the edge dislocations and slows down crack growth (CHEN et al., 2016). Chemical compatibility between alumina and aluminum niobate also contributes to material reinforcement in general, since strongly bonded particles ensure a more effective stress transfer. All these mechanisms synergistically improve mechanical strength, hardness and fracture resistance, making niobium a promising additive for various applications where high-performance and high-strength ceramics are required.

Recently, freeze-casting has attracted much attention, as it is a low-cost technique with little impact on the environment, in which the solvent temporarily acts as a binder, maintaining the desired structure after removal from the mold. High pressure differences between the feed and permeate can result in physical damage to the membrane structure, such as fractures, cracks, and even rupture of the ceramic membrane. Given the intrinsic brittleness of ceramic materials, it is recommended that membranes be developed to mechanically resist pressure gradients greater than 10 MPa, so that they can be applied, for example, in the separation of carbon dioxide from gas streams at high concentration and high pressure (>20 MPa) in subsea oil processing scenarios.

In a large-scale approach, in addition to withstanding high operating pressures during handling, transportation and assembly for use, ceramic membranes may suffer falls, bumps or cracks, possibly resulting in loss of material, reduction in efficiency and irreparable damage.

Therefore, there is a need to increase the mechanical resistance of ceramic materials to optimize the process from preparation to final application. A commonly used strategy to add mechanical strength to ceramic materials is the introduction of sintering agents during the forming process. Concerning ceramics made mainly of alumina, several oxides are mentioned in the literature for this specific purpose.

Therefore, the present disclosure proposes the use of niobia (niobium pentoxide—Nb₂O₅) as a sintering agent and structure reinforcement for alumina tubes obtained by freeze-casting.

The reinforcement mechanism consists of the formation of the secondary phase of aluminum niobate (AlNbO₄), when alumina and niobia are exposed to high temperatures. The difference in the crystal structure of alumina and niobia inhibits propagation of cracks and improves the material's mechanical properties.

Furthermore, aluminum niobate prevents edge dislocations and slows down crack growth. All these mechanisms synergistically improve mechanical strength, hardness and fracture resistance, making niobium a promising additive for various applications where high-performance and high-strength ceramics are required.

### SUMMARY OF THE DISCLOSURE

The present disclosure relates to embodiments of a method for manufacturing a ceramic material, the ceramic material itself and the use thereof for manufacturing a ceramic membrane. More particularly, the object of the present disclosure has the inventive concept of using ceramic materials obtained by technique of freeze-casting with high mechanical resistance for application as membranes, membrane supports and filters.

Some reports and patent documents disclose the production of ceramic filters, supports and membranes using conventional techniques, or discuss the use of niobia and aluminum comprising compounds.

Document PI 9903929-0 A refers to the production of ceramic membranes and more specifically to the deposition of ion transport membranes on porous substrates.

Document PI0702837-7 A2 relates to a method of manufacturing a ceramic porous membrane in which an even porous membrane having fewer coarse and/or large pores, fewer defects and having a small membrane thickness can be obtained with less membrane formation time. A method of manufacturing a ceramic porous membrane formed on the inner wall surface of the through holes of a cylindrical or lotus root-like porous base element is described.

Document PI 0717523-0 A2 refers to a ceramic porous membrane and a ceramic filter, and to the production of asymmetric membranes by depositing several layers on a ceramic porous substrate. The method of obtaining the support is not specified.

Document PI 1013068-3 A2 describes a ceramic monolith type pervaporation membrane and a vapor permeable ceramic membrane. The disclosure describes a ceramic cylindrical body made of several channels to be used in ceramic membranes. The method of obtaining the ceramic body is not described.

The disclosure described in document BR 112014014370-6 A2 relates to catalytic membrane reactors (CMR). Its main purpose is to improve the oxygen semi-permeation of ceramic membranes implemented in catalytic membrane reactors.

Document BR 112020013645-0 A2 describes a ceramic membrane obtained by the nanoporous selective sol-gel route, selective membrane structures and related methods.

A description of ceramic membranes through freezecasting is given by patent US242290 B2. Application of this material is directed towards size separation based filtration. No strategies are recited for improving the mechanical strength of heat-treated material.

The blend Al₂O₃—Nb₂O₅ is described in document WO 2012/083395, which reports the manufacture of a sintered ceramic material containing the composition referred to in the present patent, containing alumina and niobium pentoxide. The ceramic material thus produced is suitable for the production of convex-concave plates for the preparation of articles resistant to ballistic impacts.

Other state-of-the-art documents discuss ceramic materials composed of aluminum oxide and niobium pentoxide, but in different shapes and obtained using techniques other than the one proposed herein.

GOMES, L B et a. (2016) suggests that niobia can be used as an additive for alumina sintering due to the reaction at high temperatures with the formation of AlNbO₄, resulting in a highly densified ceramic final product, not to mention any application of the obtained material. In fact, said document focuses on traditional sintering and is completely silent on how different niobia concentrations and specific process conditions can significantly affect the final properties.

Document Marçal et. al. (2017) discusses an alumina containing material doped with AlNbO₄ as a ceramic reinforcement. The reinforcement mechanism of the ceramic material doped with aluminum niobate consists of increasing the diffusivity during heat treatment, promoting increased densification combined with a reduced the energy barrier to promote sintering.

The document by Lucas Bonan Gomes (2016) addresses the emergence of the AlNbO_{4 phase} as a grain growth control agent for ceramic materials obtained by pressing is completely silent on pore formation.

In general, the proposals of the three aforementioned documents are centered on the study of the addition of Nb₂O₅ and/or AlNbO₄ in ceramic bodies predominantly composed of alumina, without exploring any practical applications of the materials obtained.

The present disclosure relates to embodiments of a method for manufacturing a ceramic material, the ceramic material itself and the use thereof for manufacturing a ceramic membrane.

In an embodiment, the present disclosure also proposes a ceramic material in the shape of a hollow tube, composed of aluminum oxide and niobium pentoxide, intended for use in ceramic membranes. The ceramic material has high mechanical strength, as demonstrated by flexural strength tests, making it suitable for use under high pressure conditions.

### BRIEF DESCRIPTION OF THE DRAWINGS

In order for the disclosure to be understood more easily, FIGS. 1 to 7, which accompany this specification and are an integral part thereof, are presented by way of illustration but are not intended to limit the disclosure.

FIG. 1 is a schematic representation of the freeze-casting process according to an embodiment of the present disclosure.

FIG. 2 shows the diffractogram of alumina tubes doped with 5.0 wt % Nb₂O₅, treated at different sintering temperatures, according to an embodiment of the present disclosure.

FIG. 3 refers to a graph of the open porosity of alumina tubes doped with niobia and heat treated at different temperatures, according to an embodiment of the present disclosure.

FIG. 4 is a scanning electron microscopy image of alumina containing 1.0% niobia and heat treated at 1500° C.+1400° C., according to an embodiment of the present disclosure.

FIG. 5 is a scanning electron microscopy image of alumina containing 3.0% niobia and heat treated at 1500° C.+1400° C., according to an embodiment of the present disclosure.

FIG. 6 is a scanning electron microscopy image of alumina containing 5.0% niobia and heat treated at 1500° C.+1400° C., according to an embodiment of the present disclosure.

FIG. 7 is a SEM-EDS image of alumina tubes doped with 5% Nb₂O₅ and heat treated at 1600° C.+1500° C., according to an embodiment of the present disclosure.

### DETAILED DESCRIPTION OF THE DISCLOSURE

The present disclosure relates to embodiments of a method for manufacturing a ceramic material, the ceramic material itself and the use thereof for manufacturing a ceramic membrane and/or a membrane support for fluid separation. The method of the present disclosure is a type of freeze casting.

The freeze-casting process requires a meticulous study of the suspension rheology to ensure that the additives do not cause disturbances in the suspension stability, unlike pressing, which consists, in a simplified manner, of mixing the raw material with low water content, followed by application of pressure, making it challenging to compare similar compositions in different techniques. It is noteworthy that the uniqueness of the material obtained by freeze-casting lies in the hierarchical orientation of the pores, whose physicochemical properties can be affected by the addition of different components at any concentrations.

Thus, the present disclosure relates to a method for manufacturing a ceramic material comprising the steps of:
(a) homogenizing aluminum oxide, niobium pentoxide and solvent;
(b) ultrasonicating the blend obtained in step (a);
(c) adding an aliquot of the prepared suspension to the empty cavity of a mold, particularly between a polymer mold and a metal mold;
(d) closing the mold;
(e) immersing the mold into a bath containing coolant liquid for a period of time sufficient to ensure that all parts are fully frozen, preferably for a minimum of 30 seconds;
(f) removing the ceramic body from the mold; and
(g) removing the solidified phase by means of sublimation, obtaining a green tube;
(h) sintering the green tube to obtain a solid structure.

In one embodiment of the method for manufacturing a ceramic material according to the present disclosure, niobium pentoxide is added in a concentration of about 0.25% to about 5.0%, relative to the mass of alumina. In an embodiment, niobium pentoxide is added at a concentration of about 0.25%, about 0.5%, about 1.0%, about 3.0% or about 5.0%, in relation to the mass of alumina.

In one embodiment, the solvent of step (a) of the method for manufacturing a ceramic material according to the present disclosure is selected from pore-forming agents such as water, camphene, and tert-butanol, water being the preferred agent.

In one embodiment, step (a) may further comprise one or more additives selected from organic binders, electrostatic dispersant, and mixtures thereof.

In an embodiment, the organic binder is selected from polyvinyl alcohol, starch, carboxymethyl cellulose, polyethylene glycol, polyacrylic acid, methyl cellulose, polyvinylpyrrolidone, gelatin, preferably polyvinyl alcohol.

In an embodiment, the electrosteric dispersant is selected from Dolapix CE64 electrosteric dispersant (also known as “citric acid ethanolamine salt”), polyacrylic acid, sodium polyphosphate, citric acid, preferably electrosteric dispersant Dolapix CE64 (citric acid ethanolamine salt).

Optionally, homogenization of the components of step (a) of the method for manufacturing a ceramic material according to the present disclosure is carried out by means of magnetic stirring, mechanical stirring or milling.

In an embodiment, the time length for all parts be completely frozen in step (e) of immersing the mold into a bath containing coolant liquid is about 30 seconds and may be increased as required until the end of said freezing. For example, the mold can be immersed into a bath containing coolant liquid for a period of time of about 30 seconds, about 60 seconds, about 90 seconds, until it freezes completely.

In an embodiment, sublimation of step (g) takes place at a temperature of about −55° C., at a pressure below about 120 cmHg (approximately about 160 kPa). Preferably, sublimation of step (g) is carried out for a minimum time of about 24 hours to terminate the freeze-drying cycle.

In an embodiment of the method for manufacturing a ceramic material according to the present disclosure, the sintering of step (h) is carried out under heating at about 5° C./min to a temperature of about 1400° C. to about 1600° C., for about 10 minutes, followed by cooling to a temperature of about 1300° C. to about 1500° C. for about 1 hour.

The solid structure obtained by the method for manufacturing a ceramic material according to the present disclosure is a tubular membrane, preferably a tubular microporous membrane.

In general terms, the emergence of the AlNbO₄ phase correlates with an increased mechanical strength of ceramic materials composed of alumina and niobia and heat treated at temperatures greater than 1400° C. Incorporation of a sintering additive as well as induction of the formation of a secondary phase in a ceramic material must be carefully studied for each processing. The secondary phase, which precipitates at the grain boundaries, can have different behaviors in relation to the thermal expansion coefficient when subjected to high temperatures, as well as to the evolution of the chemical reaction and processing conditions. Depending on each condition, formation of the secondary phase can be harmful to the material structure and may, for example, lead to the formation of cracks, which is why it is necessary to study each formulation of ceramic mass. Moreover, formation of the secondary phase is intrinsically linked to the initial particle packing conditions, a variable that behaves differently for each specific processing technique and condition, including whether pressure was applied or not. Therefore, the method now developed had to be designed in a unique and innovative manner, not corresponding to what is described in the literature for the use of niobia in other applications.

The reinforcement mechanisms of alumina tubes obtained by freeze-casting can be summarized in two main factors. The first is the presence of aluminum niobate between the alumina particles, which reinforces the tube structure and allows the formation of a microstructure having fewer defects. Incorporation of the secondary phase acts as a reinforcing phase, inhibiting crack growth with the application of stress. The use of sintering agents can also help minimize the occurrence of cracks and/or other defects in the final ceramic material, improving the overall integrity and homogeneity of the microstructure.

The second strengthening mechanism is the reduction of porosity resulting from the heat treatment that is linked to liquid phase sintering, due to the addition of the sintering agent niobium pentoxide and the increased sintering temperature. Pores act as stress concentrators and are the main cause of defects in ceramic products, as they facilitate the onset of cracks and, therefore, possible fracture. Pore size distribution and total porosity change the properties of ceramics.

Variation in processing methods and final shapes of ceramic products can lead to significant differences in their mechanical properties, even when the chemical composition is similar. These possible variations are not predictable and often give rise to surprises, which can be either negative or positive. The pressing and freeze-casting processes result in distinct microstructures, pore formation and grain orientation. The manner by which grains and phases are organized can strongly influence mechanical properties. Furthermore, flexural strength tests are a more comprehensive assessment of the material, incorporating key variables such as thickness, diameter and test spacing. These parameters are key in determining mechanical properties, since the test considers the material in its entirety, providing a more comprehensive analysis in contrast to surface analysis techniques, such as microhardness. Such more comprehensive approach, unlike what has been described in the state of the art up to the time of the present disclosure, is essential for an accurate and contextualized understanding of the mechanical characteristics of the material, particularly in applications that involve different forms and processing methods.

The present disclosure provides, among other objects, ceramic materials that can be used as microfiltration membranes and/or membrane supports for fluid separation.

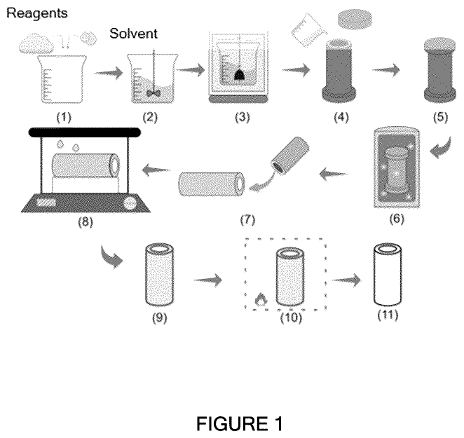

In an embodiment, the method for manufacturing a ceramic material according to the present disclosure comprises the steps of preparing tubular microfiltration membranes by the freeze casting process related to the schematic representation illustrated in FIG. 1.

The preparation of colloidal suspensions for the manufacture of ceramics by freeze-casting is similar to the preparation of slip for slip casting. Firstly, as illustrated in step (1), the ceramic powder, solvent and additives have to be homogenized. The inorganic starting material will be the main metal oxide (aluminum oxide) and the sintering agent (niobium pentoxide). The additives include the organic binder (polyvinyl alcohol), responsible for the cohesion of the ceramic particles after consolidation, and the electrostatic dispersant, which provides stabilization of the suspension. The solvent is the pore-forming agent.

To ensure homogenization of the components, mixing can be carried out using magnetic stirring, mechanical stirring or a mill. This step is illustrated in step (2).

After the mixing step (2), the suspension can be ultrasonicated (3) to improve particle dispersion and disaggregation. Suspension stability must be controlled to avoid the formation of defects and the phenomenon of segregation during freezing, avoiding density and porosity gradients in the end material.

An aliquot of the previously prepared suspension with the reagents of interest is added to the empty cavity of the mold (4), more specifically between the polymer mold and the metal mold.

In the present disclosure, a mold for the external walls made of copper and a mold for the internal walls made of polymethylene oxide were used, not being limited to this geometry or these materials. The aforementioned mold is capable of producing hollow tubes of up to 10 cm, not being limited to this size.

This mold is closed (5) and immersed into a bath containing coolant liquid (6), liquid nitrogen at a temperature of −197° C. can be used and kept immersed for a sufficient time to ensure complete freezing of all parts.

After completing the freezing required to form an ordered pore structure, the upper and lower metal covers are removed, as well as the internal polymeric mold and the mold is demolded (7). Removal of the ceramic body must be made at low temperatures to prevent the solid solvent from turning into liquid and the ordered pore structure from breaking down. The ceramic body is removed while still frozen and kept refrigerated until the phase of solvent removal.

The removal step of the solidified phase is carried out by sublimation, when the solvent is converted into the gaseous phase. When the solvent used is water, a piece of equipment designated as freeze-dryer is preferably used. This step (8) can be called lyophilization and is usually carried out under temperature conditions of −55° C. and a pressure below 120 cmHg. It usually takes at least 24 hours to complete the freeze-drying cycle.

After the ceramic consolidation stage, the prepared tube is called a “green tube” (9). When the ceramic body is in a “green” state, the inorganic particles are connected by weak bonds created mainly by the organic binder.

To transform the green tube into a solid structure, heat treatment (10) must be carried out at high temperatures, designated as sintering. Transformation of the green body into a solid structure is through the formation of bonds between the inorganic particles during heat treatment. The treatment program used is called two-stage sintering and basically consists of heating to a sufficiently high temperature, which is maintained for a few minutes, and cooling to a temperature 100° C. lower, designated as the plateau temperature, which is maintained for 60 minutes. Such two-step sintering prevents the growth of ceramic particles and contributes to increased mechanical strength due to inhibition of the particle growth process, as reported by Chen and Wang, 2000.

An example of a sintering program used was heating at 5° C./min to 1600° C., held at that temperature for 10 minutes and subsequent cooling to 1500° C. and held at that temperature for one hour and is represented by the code 1600° C.+1500° C.

Another example of a sintering program used was heating at 5° C./min to 1500° C., held at that temperature for 10 minutes and subsequent cooling to 1400° C. and held at that temperature for one hour and is represented by the code 1500° C.+1400° C.

An third example of a sintering program was heating at 5° C./min to 1400° C., held at that temperature for 10 minutes and subsequent cooling to 1300° C. and held at that temperature for one hour and is represented by the code 1400° C.+1300° C.

After such sintering step, the end tubular microporous membrane is obtained (11).

The present disclosure further relates to a ceramic material comprising aluminum oxide, niobium pentoxide and aluminum niobate, wherein:
aluminum oxide is present in a range of about 95 to about 100% w/w;
niobium pentoxide is present in a range of about 0 to about 5% w/w; and
aluminum niobate is present in a range of about 0 to about 4% w/w.

The ceramic material according to the present disclosure comprises pores in the range of about 0.04 μm to about 11.0 μm.

In an embodiment, the ceramic material according to the present disclosure is a tubular microporous membrane, and/or a membrane support, and can be obtained by the method for manufacturing a ceramic material described.

In the ceramic material of the present disclosure, niobium oxide is added to cause the formation reaction of AlNbO₄, which will preferably be formed at the grain boundaries and, under stress, will inhibit the growth of cracks along the grain boundary, thus reinforcing the physical structure and increasing the mechanical strength of said material.

The ceramic material of the present disclosure is intended for use in the oil, petroleum and gas field and is particularly useful in the manufacture of resistant ceramic membranes. Furthermore, the present disclosure has the potential to be used in other fields, such as:

Thermal insulators: The pore structure acts as a thermal barrier, reducing heat transfer. They find application in high temperature environments, such as furnaces and heat management systems. Other fields of application are aircraft construction and coating products (SHAHBAZI et al., 2020).

Biomedical implants: Bone implants and scaffolds for tissue engineering. The pore structure simulates the bone's natural porosity, facilitating cell growth and promoting tissue regeneration (SOUSA et al., 2021).

Catalysis supports: The controlled pore structure provides a high surface area for catalyst deposition, facilitating catalytic activity and stability in various chemical processes, such as petrochemical refining and exhaust gas treatment (SOUSA et al., 2021).

Solid oxide fuel cells: Transport of reagents and products, improving the performance and efficiency of the fuel cell. They can be used as a support structure for other functional layers in fuel cell stacking (PIKALOVA & KALININA, 2021).

Chemical reactors: Application in reaction vessels or catalyst beds in chemical reactors. Controlled porosity allows for efficient mass transport and control of the reaction kinetics, making them suitable for various chemical syntheses and process applications (JULBE et al., 2001, LIU et al., 2018, RITCHIE & RICHARDSON, 2001).

### EXAMPLES AND RESULTS

On a research basis, α-Al₂O₃ tubular membranes were produced by the freeze-casting processing technique.

During the step of preparing the ceramic suspension, powdered niobium pentoxide was added in the monoclinic phase at concentrations of 0.25%, 0.5%, 1.0%, 3.0% and 5.0% in relation to the mass of alumina. After the step of forming the green body, the tubes were sent for heat treatment (sintering) without applying pressure and under atmospheric air.

The sintering programs consisted of heating at 5° C./min to a certain temperature, holding for 10 minutes, and subsequent cooling to a temperature 100° C. lower and holding it for one hour. Therefore, the temperature pairs used in each heat treatment were: 1600° C.+1500° C.; 1500° C.+1400° C. and 1400° C.+1300° C.

The materials obtained were characterized by the following techniques: X-ray diffraction (XRD); 3-point flexural strength; porosity by the Archimedes method and scanning electron microscopy (SEM).

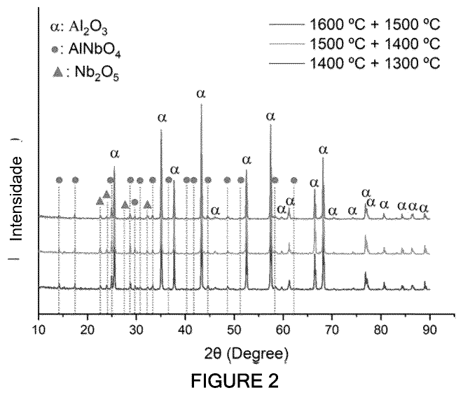

Crystal structures of the alumina tube samples doped with 5% Nb₂O₅ and heat-treated in different sintering routes were assessed by X-ray diffraction and the results are presented in FIG. 2, which shows the diffractogram of the alumina tubes doped with 5 wt % Nb₂O₅, treated at different sintering temperatures. The results confirm the formation of aluminum niobate, which is the product of the reaction between alumina and niobium at temperatures greater than 1400° C. (CHEN et al., 2021), according to Equation 1:

$${Al}_{2} {O}_{3} + {Nb}_{2} {O}_{5} 2 {AlNbO}_{4} \qquad Equation 1$$

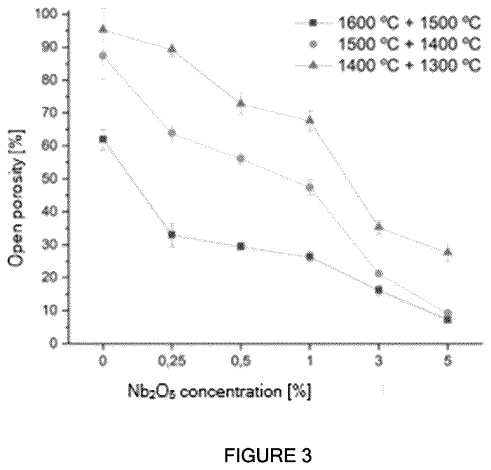

FIG. 3 shows the influence of the sintering temperature on the open porosity properties of pure alumina membranes sintered at different temperatures.

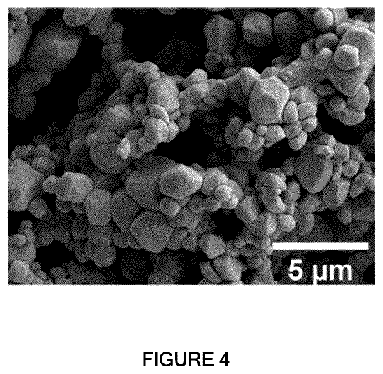

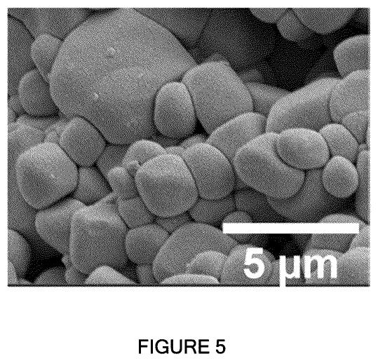

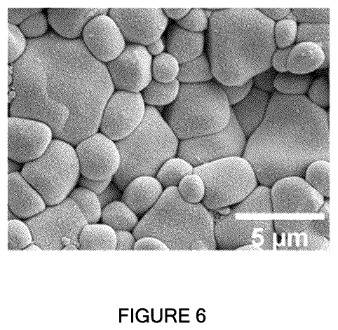

Morphology of the outer portion of Al₂O₃—Nb₂O₅ tubes was assessed by scanning electron microscopy for concentrations of 1% (FIG. 4), 3% (FIG. 5) and 5% (FIG. 6) of niobia relative to the mass of alumina.

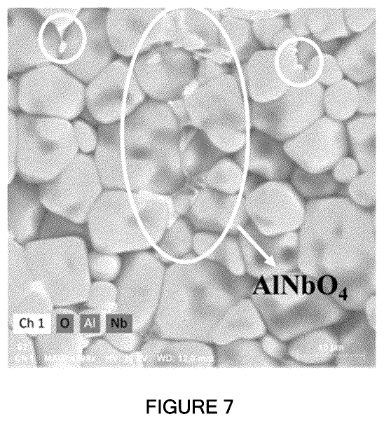

Energy dispersive X-ray spectroscopy (EDS) integrated with scanning electron microscope (SEM) was used to identify the chemical elements present in the sample. FIG. 7 shows an EDS-SEM image of the sample doped with 5% niobia. EDS analysis has identified the elements aluminum and niobium, allowing an association to be made with compound AlNbO₄, which corroborates the X-ray diffraction results and the phase diagram of alumina and niobia. The size difference between Al³⁺ (0.54 Å) and Nb⁵⁺ (0.69 Å) renders a substitutional solid solution between Nb₂O₅ and Al₂O₃ as well as the mobility of the Nb⁵⁺ ion (volumetric diffusion) in the alumina matrix impossible. Therefore, under high temperature conditions, there is a transfer of Nb₂O₅ to Al₂O₃, forming AlNbO₄.

### BIBLIOGRAPHIC REFERENCES

SHAHBAZI, M.; GHALKHANI, M.; MALEKI, H. Directional Freeze-Casting: A bioinspired method to assemble multifunctional aligned porous structures for advanced applications. Advanced Engineering Materials, vol. 22 (2000033), 2020.
JULBE, A.; FARRUSSENG, D.; GUIZARD, C. Porous ceramic membranes for catalytic reactors—overview and new ideas. Journal of Membrane Science, vol. 181, line 1 (15), p. 3-20, 2001.
LIU, T.; ZHAO, W.; WANG, Y. Robust freeze-cast bilayer dualphase oxygen transport membrane targeting chemical reactor application. ACS Applied Nano Materials, vol. 1 (8), p. 3774-3778, 2018.
SOUSA, B. M., ATHAYDE, D. D., VASCONCELOS, W. L. Mechanical behavior of tubular freeze-cast substrates with organized pore structure. Materials Research, vol. 24 (5), 2021.
ATHAYDE, D. D., DOLABELLA, A. C. A., DIAS, B. C., SOUSA, B. M., SILVA, D. G., VASCONCELOS, D. C. L., VASCONCELOS, W. L. Production and characterization of a silica-alumina membrane using novel tubular freeze-cast substrates. Materials Research, vol. 22 (2), 2019.
MAGUIRE-BOYLE, S. J., HUSEMAN, J. E., AINSCOUGH, T. J., OATLEY-RADCLIFFE, D. L., ALABDULKAREM, A. A., AL-MOJIL, S. F., BARRON, A. R. Superhydrophilic Functionalization of Microfiltration Ceramic Membranes Enables Separation of Hydrocarbons from Frac and Produced Water. Scientific Reports, 7: 12267, 2017.
CANO, G., MOULIN, P. Treatment of Boiler Condensate by Ultrafiltration for Reuse. Membranes, 2022, 12(12), 1285.
CHEN, I.-W., WANG, X.-H. Sintering dense nanocrystalline ceramics without final-stage grain growth. Nature, Vol. 404, 2000.
DIZAYEE, K. K. H., JUDD, S. J. A brief review of the status of low-pressure membrane technology implementation for petroleum industry effluent treatment. Membranes, 12(4), 391, 2022.
RITCHIE, J. T., RICHARDSON, J. T., LUSS, D. Ceramic membrane reactor for synthesis gas production, AIChE Journal, vol. 47(9), 2092-2101, 2001.
KISSZÉKELYI, P., NAGY, S., FEHÉR, Z., HUSZTHY, P., KUPAI, J. Membrane-supported recovery of homogeneous organocatalysts: a review. Chemistry, vol. 2(3), p. 742-758, 2020.
JIANG, H., MENG, L., CHEN, R., JIN, W., XING, W., XU, N. Progress on porous ceramic membrane reactors for heterogeneous catalysis over ultrafine and nano-sized catalysts. Chinese Journal of Chemical Engineering, vol. 21 (2), p. 205-215, 2013.
ZOU, Y., JIANG, H., GAO, H., CHEN, R. Efficient recovery of ultrafine catalysts from oil/water/solid three-phase system by ceramic microfiltration membrane. Korean Journal of Chemical Engineering, vol. 33, p. 2453-2459, 2016.
RASOULI, Y., PARIVAZH, M. M., ABBASI, M., AKRAMI, M. The effect of ceramic membranes' structure on the oil and ions removal in pretreatment of the desalter unit wastewater. Membranes (Basel), vol. 12(1): 59, 2022.
SOUZA, M. Y. M., LIRA, H. L., SANTANA, L. N. L., RODRÍGUEZ, M. A. Preparation and application in crude oil-water separation of clay-based membranes. Materials Research, vol. 24(4), 2021.
SALEHI, E., MADAENI, S. S., SHAMSABADI, A. A., LAKI, S. Applicability of ceramic membrane filters in pretreatment of coke-contaminated petrochemical wastewater: Economic feasibility study. Ceramics International, vol. 40 (3), p. 4805-4810, 2014.
DIZAYEE, K. K. H., JUDD, S. J. A brief review of the status of low-pressure membrane technology implementation for petroleum industry effluent treatment. Membranes, vol. 12(4), 391, 2022.
CHEN, X., LIU, G., JIN, W. Natural gas purification by asymmetric membranes: An overview. Green Energy & Environment, vol. 6, Issue 2, p. 176-192, 2021.
IMTIAZ, A., OTHMAN, M. H. D., JILANI, A., KHAN, I. U., KAMALUDIN, R., IQBAL, J., AL-SEHEMI, A. G. Challenges, opportunities and future directions of membrane technology for natural gas purification: a critical review. Membranes (Basel), vol. 12(7): 646, 2022.
PIKALOVA, E. Y., KALININA, E. G. Solid oxide fuel cells based on ceramic membranes with mixed conductivity: improving efficiency. Russian Chemical Reviews, vol. 90, N.6, 2021.
YANG, R., QI, Z., GAO, Y., YANG, J., ZHOU, Y., LIU, H., PENG, L., JIAO, J. Effects of alumina sols on the sintering of a-alumina ceramics. Ceramics International, vol. 46, I. 13, p. 20865-20870, 2020.
CHEN, P.-C., CHENG, C.-W., KAO, I-C., TUAN, W.-H., LIAN, T.-W., NAITO, M. Effect of co-doping NiO and Nb₂O₅ on phase stability and mechanical properties of Y₂O₃-stabilized ZrO₂/Al₂O₃ composites. Advanced Powder Technology, vol. 27, I. 3, p. 877-881, 2016.
CHEN, J., CHEN, Q., QU, S., XIANG, H. P., WANG, C., GAO, J. B., FENG, A. H., CHEN, D. L. Oxidation mechanisms of an intermetallic alloy at high temperatures. Scripta Materialia, vol. 199, 2021.
SONG, X., JIAN, B., JIN, J. Preparation of porous ceramic membrane for gas-solid separation. Ceramics International, Vol. 44, I. 16, p. 20361-20366, 2018.
ZHANG, W., PENG, C., LIU, D., CHENG, Y., WU, J. Preparation of fused silica membrane with high performance for high temperature gas filtration by sealing and spray coating. Ceramics International, vol. 45, I. 9, p. 1160711614, 2019.
BERNARDO, P., DRIOLI, E. Membrane gas separation progresses for process intensification strategy in the petrochemical industry. Petroleum Chemistry, Vol. 50, No. 4, pp. 271-282, 2010.
GOMES, L. B.; LIIMA, M. M. O.; PEREIRA, A. S.; BERGMANN, C. P. Adição de Nióbia em Alumina e Seu Efeito na Microestrutura do Sinterizado. In: 22^{nd} Brazilian Congress of Materials Science and Engineering, 2016, Natal/RN. Proceedings of the 22^{nd} CBECiMat. São Paulo: Metallum, 2016. p. 446456.
Marçal, Rubens Lincoln Santana Blazutti; Santos, Jheison Lopes dos; Louro, Luis Henrique Leme. SINTESE DE AlNbO₄ E SEU COMPORTAMENTO COMO ADITIVO DE SINTERIZAçÃO DA ALUMINA, p. 3537-3546. In: 72^{nd} ABM Annual Congress, São Paulo, 2017. ISSN: 2594-5327, DOI 10.5151/1516-392X-30937.
Gomes, Lucas Bonan. Estudo Da Formação Do AlNbO₄ No Sistema 0(x Al₂O₃+1-x Nb₂O₅) Por Técnicas De Difração De Raios X E Microscopia Eletrônica Em Função Da Composição E Temperatura De Tratamento Térmico. 2016.

1. A method for manufacturing a ceramic material, the method comprising:
(a) homogenizing aluminum oxide, niobium pentoxide and solvent so as to define a blend;
(b) ultrasonicating the blend obtained in step (a) so as to define a prepared suspension;
(c) adding an aliquot of the prepared suspension to an empty cavity of a mold;
(d) immersing the mold into a coolant liquid-containing bath for sufficient time to ensure that all parts are completely frozen and the prepare suspension defines a ceramic body;
(e) removing the ceramic body from the mold;
(f) removing the solidified phase by means of sublimation hence obtaining a green tube; and
(g) sintering the green tube to obtain a solid structure.

2. The method according to claim 1, wherein the niobium pentoxide is added in a concentration of from 0.25% to 5.0% relative to the mass of alumina.

3. The method according to claim 2, wherein the niobium pentoxide is added in a concentration of 0.25%, 0.5%, 1.0%, 3.0% or 5.0% relative to the mass of alumina.

4. The method according to claim 1, wherein the solvent in step (a) is selected from pore-forming agents, preferably water, camphene and tert-butanol, more preferably water.

5. The method according to claim 1, wherein the step (a) comprises one or more additives selected from organic binders, an electrostatic dispersant, and mixtures thereof.

6. The method according to claim 5, wherein the organic binder is selected from polyvinyl alcohol, starch, carboxymethyl cellulose, polyethylene glycol, polyacrylic acid, methyl cellulose, polyvinylpyrrolidone, gelatin, preferably wherein the organic binder is polyvinyl alcohol.

7. The method according to claim 1, wherein the electrostatic dispersant is selected from citric acid ethanolamine salt, polyacrylic acid, sodium polyphosphate, citric acid, preferably wherein the electrostatic dispersant is citric acid ethanolamine salt.

8. The method according to claim 1, wherein the homogenizing of step (a) is carried out by means of magnetic stirring, mechanical stirring, or a mill.

9. The method according to claim 1, wherein the sintering is carried out under heating at 5° C./min to a temperature of 1400° C. to 1600° C., for 10 minutes, followed by cooling to a temperature of 1300° C. to 1500° C. for 1 hour.

10. The method according to claim 1, wherein the solid structure obtained is a tubular membrane, preferably a tubular microporous membrane.

11. A ceramic material comprising:
aluminum oxide, niobium pentoxide, and aluminum niobate,
wherein aluminum oxide is present in a range of from 95% to 100% w/w,
niobium pentoxide is present in a range of from 0 to 5% w/w, and
aluminum niobate is present in a range of from 0 to 4% w/w, and
wherein the ceramic material comprises pores in the range of from 0.04 μm to 11 μm.

12. The ceramic material according to claim 11, wherein the ceramic material comprises one or more of a tubular microporous membrane or a membrane support.

13. The ceramic material according to claim 12, wherein the ceramic material is obtained by the method as defined in claim 1.

14. A method of use of the ceramic material as defined in claim 11, wherein the ceramic material is positioned in one or more of microfiltration membranes or membrane support for fluid separation.
